(19) United States
(12) Patent Application Publication
(10) Pub. No.: US 2025/0222815 A1
(43) Pub. Date: Jul. 10, 2025

(54) MANAGING CHARGING OF ELECTRIC VEHICLES

(71) Applicant: LIIKENNEVIRTA OY / VIRTA LTD, Helsinki (FI)

(72) Inventors: Jani HENRIKSSON, Espoo (FI); Juha KARPPINEN, Espoo (FI)

(73) Assignee: LIIKENNEVIRTA OY / VIRTA LTD, Helsinki (FI)

(21) Appl. No.: 18/853,537

(22) PCT Filed: Apr. 3, 2023
(86) PCT No.: PCT/FI2023/050183

§ 371 Date: Oct. 2, 2024

(30) Foreign Application Priority Data
Apr. 4, 2022 (FI) 20225288

(51) Int. Cl. B60L 53/67

(52) U.S. Cl. CPC B60L 53/67

(57) ABSTRACT

Various example embodiments relate to a solution for managing charging of electric vehicles. An apparatus may be configured to receive a charging transaction request associated with a user to charge an electric vehicle, the charging transaction request being associated with a charging station; determine that the user belongs to a priority charging user group, the priority charging user group being associated with a charging station group comprising a plurality of charging stations including the charging station; and prioritize the charging transaction relating to the charging station of the charging station group.

### TECHNICAL FIELD

Various example embodiments generally relate to the field of charging electric vehicles. In particular, some example embodiments relate to a solution for managing charging stations used to charge electric vehicles.

### BACKGROUND

Charging stations (CS) are used to charge electric vehicles (EV). Charging stations may be managed by a managing entity. A plurality of charging stations may be arranged to a single geographical location to serve electric vehicles. When more than one charging station is arranged to a single location, there may be a specific maximum current limit that the plurality of charging stations altogether cannot exceed. When more than one electric vehicle is being charged at the same time, it may be necessary to apply some load management solution, for example, Dynamic Load Management (DLM), in order to share the maximum current limit with the electric vehicles. The load management solution then adjusts a charging current of individual charging stations up or down so that the maximum current limit is not exceeded.

There exists also implementations in which some charging stations in a charging station group comprising a plurality charging stations may be considered as “priority charging stations” or “VIP charging stations”, and they may get a higher and/or assured charging power compared to the rest of the charging stations.

Based on the above, there is a need for a more versatile solution for managing charging transactions of charging stations in a charging station group.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that allows prioritizing predetermined users when charging electric vehicles in charging stations. This benefit may be achieved by the features of the independent claims. Further implementation forms are provided in the dependent claims, the description, and the drawings.

According to a first aspect, an apparatus may comprise at least one processor and at least one memory including computer program code. The at least one memory and the computer program code are configured to, with the at least one processor, cause the apparatus at least to: receive a charging transaction request associated with a user to charge an electric vehicle, the charging transaction request being associated with a charging station; determine that the user belongs to a priority charging user group, the priority charging user group being associated with a charging station group comprising a plurality of charging stations including the charging station; and prioritize the charging transaction relating to the charging station of the charging station group.

In an implementation form of the first aspect, the at least one memory and the computer program code are configured to, with the at least one processor, cause the apparatus at least to control to provide a full charging power of the charging station to the charging station of the charging station group.

In an implementation form of the first aspect, the at least one memory and the computer program code are configured to, with the at least one processor, cause the apparatus at least to control to share a total charging power of the charging stations of the charging station group between the charging station and at least one other charging station of the charging station group having a simultaneous charging transaction associated with at least one other user of the priority charging group.

In an implementation form of the first aspect, the at least one memory and the computer program code are configured to, with the at least one processor, cause the apparatus at least to: control to provide a maximum charging power to the user and to at least one other user of the priority charging group with corresponding charging stations of the charging station group, and control to share the remaining charging power of a total charging power of the charging stations of the charging station group to at least one non-priority user.

In an implementation form of the first aspect, the at least one memory and the computer program code are configured to, with the at least one processor, cause the apparatus at least to: determine that the user belongs to a priority charging group having a priority level; and prioritize the charging transactions relating to the charging station of the charging station group based on the priority level of the priority charging group.

In an implementation form of the first aspect, the charging stations of a charging station group are located in the same geographical location.

In an implementation form of the first aspect, the charging stations of a charging station group are located in at least two different geographical locations.

In an implementation form of the first aspect, the at least one memory and the computer program code are configured to, with the at least one processor, cause the apparatus at least to determine that there exists a validity condition associated with the user belonging to the priority charging user group; and prioritize the charging transaction relating to the charging station of the charging station group based on the validity condition associated with the user.

In an implementation form of the first aspect, the at least one memory and the computer program code are configured to, with the at least one processor, cause the apparatus at least to identify each user based on a unique user identifier.

According to a second aspect, a method comprises receiving, by an apparatus, a charging transaction request associated with a user to charge an electric vehicle, the charging request transaction being associated with a charging station; determining, by the apparatus, that the user belongs to a priority charging user group, the priority charging user group being associated with a charging station group comprising a plurality of charging stations including the charging station; and prioritizing, by the apparatus, the charging transaction relating to the charging stations of the charging station group.

In an implementation form of the second aspect, the method further comprises controlling, by the apparatus, to provide a full charging power of the charging station to the charging station of the charging station group.

In an implementation form of the second aspect, the method further comprises controlling, by the apparatus, to share a total charging power of the charging stations of the charging station group between the charging station and at least one other charging station of the charging station group having a simultaneous charging transaction associated with at least one other user of the priority charging group.

In an implementation form of the second aspect, the method further comprises controlling, by the apparatus, to provide a maximum charging power to the user and to at least one other user of the priority charging group with corresponding charging stations of the charging station group, and controlling, by the apparatus, to share the remaining charging power of a total charging power of the charging stations of the charging station group to at least one non-priority user.

In an implementation form of the second aspect, the method further comprises: determining, by the apparatus, that the user belongs to a priority charging group having a priority level; and prioritizing, by the apparatus, the charging transactions relating to the charging station of the charging station group based on the priority level of the priority charging group.

In an implementation form of the second aspect, the charging stations of a charging station group are located in the same geographical location.

In an implementation form of the second aspect, the charging stations of a charging station group are located in at least two different geographical locations.

In an implementation form of the second aspect, the method further comprises determining, by the apparatus, that there exists a validity condition associated with the user belonging to the priority charging user group; and prioritizing, by the apparatus, the charging transaction relating to the charging station of the charging station group based on the validity condition associated with the user.

In an implementation form of the second aspect, the method further comprises to identifying each user based on a unique user identifier.

According to a third aspect, a computer program comprises instructions for causing an apparatus to perform at least the following: receiving a charging transaction request associated with a user to charge an electric vehicle, the charging transaction request being associated with a charging station; determining that the user belongs to a priority charging user group, the priority charging user group being associated with a charging station group comprising a plurality of charging stations including the charging station; and prioritizing the charging transaction relating to the charging stations of the charging station group.

According to a fourth aspect, a computer-readable medium comprises a computer program comprising instructions for causing an apparatus to perform at least the following: receiving a charging transaction request associated with a user to charge an electric vehicle, the charging transaction request being associated with a charging station; determining that the user belongs to a priority charging user group, the priority charging user group being associated with a charging station group comprising a plurality of charging stations including the charging station; and prioritizing the charging transaction relating to the charging stations of the charging station group.

According to a fifth aspect, an apparatus comprise means for: receiving a charging transaction request associated with a user to charge an electric vehicle, the charging transaction request being associated with a charging station; determining that the user belongs to a priority charging user group, the priority charging user group being associated with a charging station group comprising a plurality of charging stations including the charging station; and prioritizing the charging transaction relating to the charging stations of the charging station group.

According to a sixth aspect, an apparatus may comprise at least one processor and at least one memory including computer program code. The at least one memory and the computer program code are configured to, with the at least one processor, cause the apparatus at least to: receive a charging transaction request associated with a user to charge an electric vehicle, the charging transaction request being associated with a charging station; determine that the user belongs to a priority charging user group; determine that the priority charging user group is associated with a charging station group comprising a plurality of charging stations; determine that the charging station group includes the charging station; and prioritize the charging transaction relating to the charging station of the charging station group.

According to a seventh aspect, a method comprises receiving, by an apparatus, a charging transaction request associated with a user to charge an electric vehicle, the charging transaction request being associated with a charging station; determining, by the apparatus, that the user belongs to a priority charging user group; determining, by the apparatus, that the priority charging user group is associated with a charging station group comprising a plurality of charging stations; determining, by the apparatus, that the charging station group includes the charging and prioritizing, by the apparatus, the station; charging transaction relating to the charging station of the charging station group.

According to an eighth seventh aspect, a computer program comprises instructions for causing an apparatus to perform at least the following: receiving a charging transaction request associated with a user to charge an electric vehicle, the charging transaction request being associated with a charging station; determining that the user belongs to a priority charging group; determining that the priority charging user group is associated with a charging station group comprising a plurality of charging stations; determining that the charging station group includes the charging station; and prioritizing the charging transaction relating to the charging station of the charging station group.

According to a ninth aspect, a computer-readable medium comprises computer program comprising a instructions for causing an apparatus to perform at least the following: receiving a charging transaction request associated with a user to charge an electric vehicle, the charging transaction request being associated with a charging station; determining that the user belongs to a priority charging user group; determining that the priority charging user group is associated with a charging station group comprising a plurality of charging stations; determining that the charging station group includes the charging station; and prioritizing the charging transaction relating to the charging station of the charging station group.

According to a tenth aspect, an apparatus comprise means for: receiving a charging transaction request associated with a user to charge an electric vehicle, the charging transaction request being associated with a charging station; determining that the user belongs to a priority charging user group; determining that the priority charging user group is associated with a charging station group comprising a plurality of charging stations; determining that the charging station group includes the charging station; and prioritizing the charging transaction relating to the charging station of the charging station group.

Many of the attendant features will be more readily appreciated as they become better understood by reference to the following detailed description considered in connection with the accompanying drawings.

### DESCRIPTION OF THE DRAWINGS

The accompanying drawings, which are included to provide a further of understanding the example embodiments and constitute a part of this specification, illustrate example embodiments and together with the description help to understand the example embodiments. In the drawings:

FIG. 1 illustrates an example of a method for prioritizing charging transaction according to an example embodiment.

FIG. 2A illustrates an example of charging stations of a charging station group according to an example embodiment.

FIG. 2B illustrates another example of charging stations of a charging station group according to an example embodiment.

FIG. 3 illustrates a flow diagram for managing a charging session according to an example embodiment.

FIG. 4 illustrates a flow diagram for managing a charging session according to another example embodiment.

FIG. 5 illustrates an example of an apparatus 500 configured to practice one or more example embodiments.

FIG. 6 illustrates a cloud-based system according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

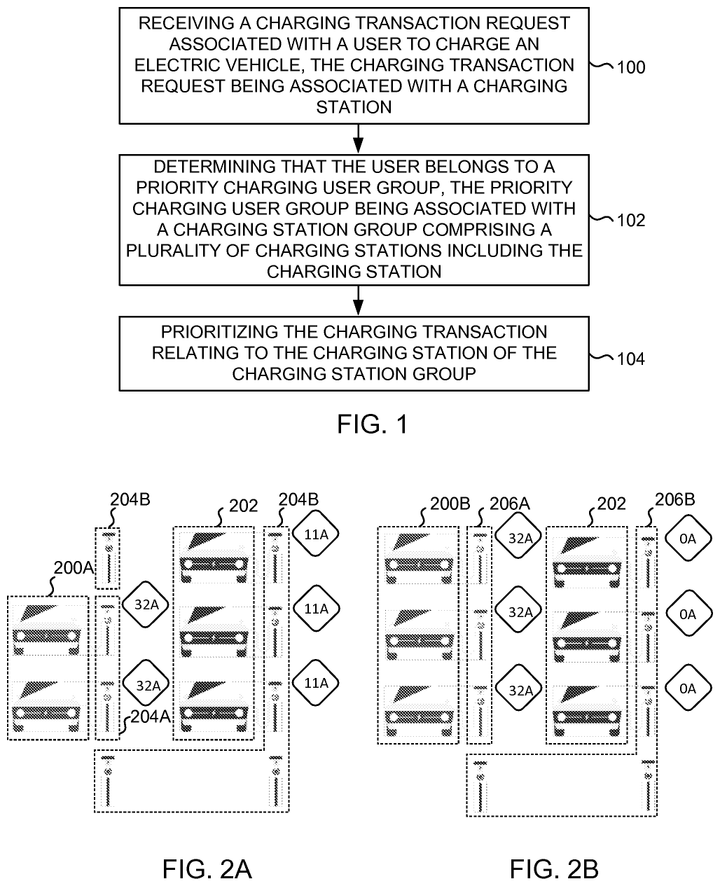

FIG. 1 illustrates an example of a method for prioritizing charging transactions according to an example embodiment. The method may be performed, for example, by a cloud-based entity or apparatus that is communicatively connected to a plurality of charging stations.

At 100 a charging transaction request associated with a user to charge an electric vehicle may be received, the charging transaction request being associated with a charging station. The term “user” used herein may refer to a user that has registered to a service that enables charging of electric vehicles at a plurality of charging stations. In the service, after a registration the user may be identified based on a unique user identifier. When a user then starts a charging transaction with a tag or a mobile application, the user identifier or another identifier associated with the user identifier may be transmitted to the cloud-based entity.

At 102 it is determined that the user belongs to a priority charging user group, the priority charging user group being associated with a charging station group comprising a plurality of charging stations including the charging station. At least one user may have earlier been associated with the priority charging user group. A single user may belong to multiple different priority charging user groups. There may be one or more priority charging user groups. For example, a first priority charging user group may be associated with a first charging station group, a second priority charging user group may be associated with a different, second charging station group etc. Additionally or alternatively, more than one priority charging group may be associated with one charging station group. Charging stations of one charging station group may be located in a single geographical location or they may be distributed in more than one geographical location. If the user does not belong to a priority charging user group, the user may treated as a normal, i.e. non-priority user.

In an example embodiment, at 102, it may be determined that the user belongs to a priority charging user group. It may also be determined that the priority charging user group is associated with a charging station group comprising a plurality of charging stations. It may also be determined that the charging station group includes the charging station.

At 104 the charging transaction relating to the charging station of the charging station group is prioritized. The prioritizing may mean, for example, that the user associated with the priority charging user group may be offered a full charging power at the charging station of the charging station group before any other simultaneous users not belonging to the priority charging user group associated with the charging station group. If more than one user belonging to the same priority charging user group associated with the charging station group is charging simultaneously at the charging stations of the charging station group, the power delivered to each user may be shared between the priority users if each user cannot be offered a full charging power of a single charging station.

FIG. 2A illustrates an example of charging stations 204A, 204B of a charging station group according to an example embodiment. In FIG. 2A, there are two priority users 200A and three non-priority users 202 charging simultaneously at one charging group comprising multiple charging stations 204A, 204B. Each charging station alone may be able to provide 32 A charging current (i.e. 22 kW) for an electric vehicle. However, an overall import limit of 96 A applies to the charging station group formed by the charging stations 204A, 204B.

In this example, both priority users 200A use 32 A thus totaling 64 A. The priority users 200A may be prioritized so that each of them receives the maximum charging power provided by the respective charging station. Each of the non-priority users 202 is thus left 11 A each as the overall import limit is 96 A. In other words, priority users may always get full power from the charging stations. The non-priority users 202 may equally share what is left from the priority users.

FIG. 2B illustrates another example of charging stations of a charging station group according to an example embodiment. In FIG. 2B, there are three priority users 200B and three non-priority users 202 charging simultaneously at one charging group comprising multiple charging stations 206A, 206B. Each charging station alone is able to provide 32 A charging current (i.e. 22 kW) for an electric vehicle. However, again the overall import limit of 96 A applies to the charging stations 206A, 206B.

In this example, each of the three priority users 200B uses 32 A thus totaling 96 A. The priority users 200B may be prioritized so that each of them receives the maximum charging power provided by the respective charging station. However, there is no charging power available to be provided via the charging stations 206B as the three priority users 200B already use all of the overall import limit of 96 A. In other words, priority users may always get full power from the charging stations, and the non-priority users may be paused until more capacity is freed up from the priority users.

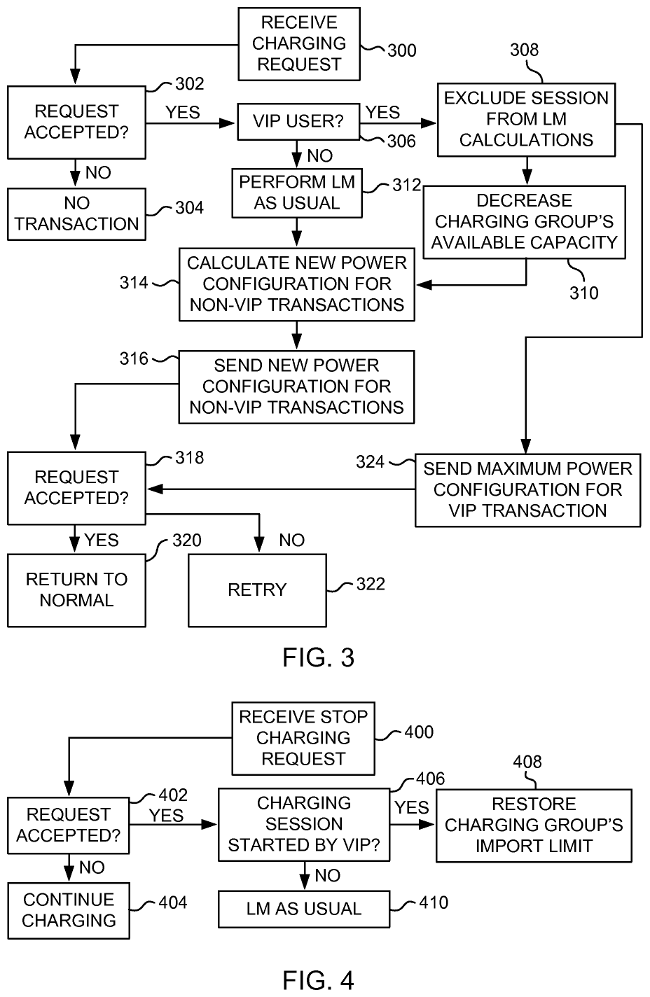

FIG. 3 illustrates a flow diagram for managing a charging session according to an example embodiment.

At 300 a cloud-based managing entity may receive a charging request from a charging station or from an application executed in a user's mobile device, for example, a smart phone. If the request originates from a charging station, it means that the user may have used, for example, a tag to identify himself/herself to the charging station. The request may comprise a unique user identifier associated with a user. In another example embodiment, the request may comprise another unique identifier, for example, a unique identifier of the tag belonging to the user, that has earlier been associated with the user identifier.

At 302 it is determined whether the request can be accepted. If the request cannot be accepted, the processing of the transactions ends at 304. If the request can be accepted, the processing proceeds to step 306.

At 306 it is determined whether the user is a priority user, i.e. a VIP user. This may comprise determining whether the user belongs to a priority charging user group, the priority charging user group being associated with a charging station group comprising a plurality of charging stations including the charging station. At least one user may have earlier been associated with the priority charging user group.

If it is determined that the user is not a priority user, i.e. a VIP user, the processing proceeds to 312, in which load management may be performed in a normal way without any priorizations. At 314 a new power configuration for non-VIP may transactions be calculated. For example, it may be determined how much charging power is to delivered to each non-priority user having a charging session at charging stations of the charging station group. At 316 new the power station group configuration may be sent to the charging station from which the charging request originated.

At 318 the charging station may determine whether the request can be accepted. At 320, if the request can be accepted, the charging station may apply the new power configuration and return to a normal operating state. At 322, if the request cannot be accepted, a retry operation may be initiated.

When it was determined at 306 that the user is a VIP user, at 308 the charging session of the VIP user is excluded from load management calculations. This may mean that the VIP user is reserved charging power prior to any non-VIP users. At 310 the charging station group's available capacity for non-VIP transactions is decreased. In other words, when the VIP user is prioritized, for example, by giving a full charging power from a charging station to the VIP user, the available capacity for non-VIP users is decreased by the amount of the full charging power. For example, when a VIP user starts charging, the import limit for the group of charging stations may be reduced by the amount that is allocated to the VIP user. If the charging station group's import limit is 96 A, and a VIP starts charging on a station where the maximum current rating is 32 A, then the charging stations group's available import limit may be calculated as: 96 A-32 A=64 A. 64 A is thus what is remaining for the non-VIP users.

Then, again at 314 a new power configuration for non-VIP transactions may be calculated by taking into account the charging power reserved for the VIP user. In an example embodiment, there may be three simultaneous VIP users charging at charging stations of a charging station group, and the charging station group's import limit may be, for example, 96 A. This then means that the three VIP users may be given all the available charging power, i.e. the import limit of 3×32 A=96 A of the charging station group. In this case, no charging power is left for non-VIP users. If then a fourth VIP user starts charging at a charging station of the charging station group, the charging station group's import limit is still 96 A, but now it will be shared by the four VIP users by a load management. The share between the four VIP users may be an even share (i.e. 24 A) or any other sharing allocation. In another example embodiment, there may be two VIP users charging at the charging stations of the charging station group, and the charging station group's import limit may again be, for example, 96 A. Both VIP users are given 32 A totaling thus 64 A, and the remaining 32 A is left for the non-VIP users. At 324 the maximum power configuration for the VIP transaction is sent to the charging station, and the processing returns back to 318.

In FIG. 3, the steps 302, 304, 318 and 320 may be performed by the charging station, while the remaining steps may be performed by the cloud-based managing entity.

FIG. 4 illustrates a flow diagram for managing a charging session according to another example embodiment.

At 400 a charging stop request may be received by a cloud-based managing entity. This may be caused by a user action at a charging station or the request may originate from an application executed in the user's mobile device.

At 402 the charging station may determine whether the request can be accepted. If the request cannot be accepted, the charging continues at 404. This may be the case, for example, when it is determined that the user does not have an ongoing charging session with the charging station. In another example embodiment, the request may not be accepted, for example, if there are too many requests being processed simultaneously, the station is faulted, etc.

If the request can be accepted, at 406 it is determined whether the charging session was started by a priority user, i.e. a VIP user. If the charging session was started by a VIP user, the import limit of the charging station group may be restored. This may mean, for example, that as the VIP user does not any more reserve any charging power, the released charging power may now be used by non-VIP users. In other words, when a VIP user starts charging, the import limit for the group of charging stations may be reduced by the amount that is allocated to the VIP user. If the charging station group's import limit is 96 A, and a VIP starts charging on a station where the maximum current rating is 32 A, then the charging stations group's available import limit may be calculated as: 96 A-32 A=64 A. 64 A is thus what is remaining for the non-VIP users. Once the VIP transaction ends, the import limit may be restored, i.e. increased back to 96 A.

If the charging session was not started by a VIP user, i.e. the charging session was started by a non-VIP user, at 410 normal load management procedures may be performed. For example, the import limit may be evenly distributed among charging stations that have a car charging. If the charging station group's import limit is 96 A, and there are four non-VIP users charging, then an equal share means 96 A/4=24 A per charging station.

In FIG. 4, the steps 402 and 404 may be performed by the charging station, while the remaining step may be performed by the cloud-based managing entity.

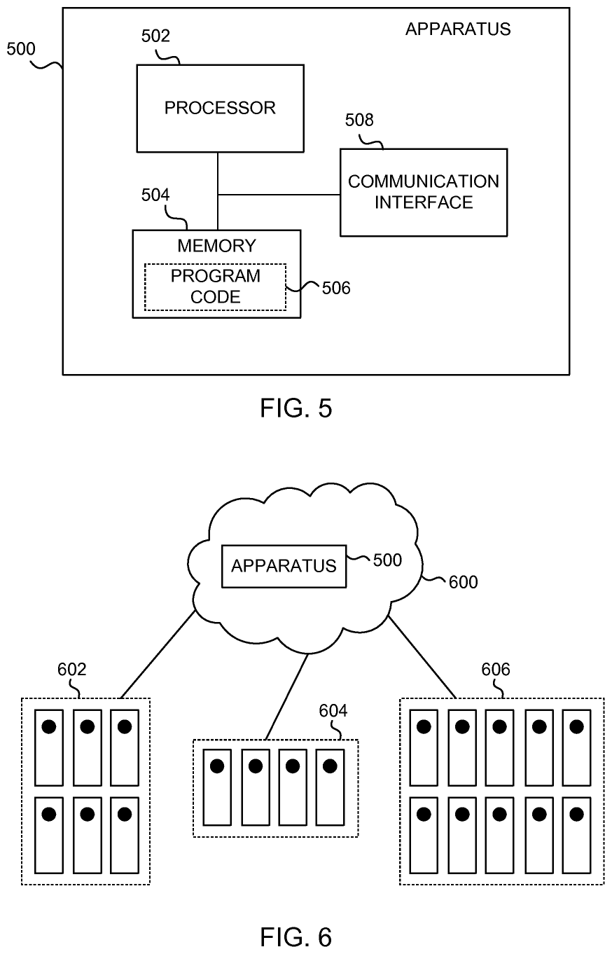

FIG. 5 illustrates an example of an apparatus 500 configured to practice one or more example embodiments. The apparatus 500 may comprise at least one processor 502. The at least one processor 502 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 500 may further comprise at least one memory 504. The at least one memory 504 may be configured to store, for example, computer program code or the like, for example, operating system software and application software. The at least one memory 504 may comprise one or more volatile memory devices, one or more non-volatile memory devices, and/or a combination thereof. For example, the at least one memory 504 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 500 may further comprise a communication interface 508 configured to enable apparatus 500 to transmit and/or receive information to/from other devices, for example, charging stations. In one example, the apparatus 500 may use the communication interface 508 to transmit or receive signaling information and data in accordance with at least one data communication or cellular communication protocol. The communication interface 508 may be configured to provide at least one wireless radio connection, such as, for example, a 3GPP mobile broadband connection (e.g. 3G, 4G, 5G, 6G etc.) or a wired connection. The communication interface 508 may comprise, or be configured to be coupled to, at least one antenna to transmit and/or receive radio frequency signals.

When the apparatus 500 is configured to implement some functionality, some component and/or components of the apparatus 500, for example, the at least one processor 502 and/or the at least one memory 504, may be configured to implement this functionality. Furthermore, when the at least one processor 502 is configured to implement some functionality, this functionality may be implemented using the program code 506 comprised, for example, in the at least one memory 504.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 500 may comprise means for performing at least one method described herein. In an example embodiment, the means may comprise the at least one processor 502, the at least one memory 504 including program code 506 configured to, when executed by the at least one processor, cause the apparatus 500 to perform the method.

The apparatus 500 may comprise, for example, a computing device or a server, for example, a cloud-based computer or a cloud-based server. The term “cloud-based” used herein may refer to any device that may be connected to one or more charging stations via a wired or wireless data connection. Although the apparatus 500 is illustrated as a single device it is appreciated that, wherever applicable, functions of the apparatus 500 may be distributed to a plurality of devices, for example, to implement example embodiments as a cloud computing service.

The apparatus may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

FIG. 6 illustrates a cloud-based system according to an example embodiment.

The apparatus 500 discussed in more detail relating to FIG. 5 may be arranged at any appropriate physical location, and thus the apparatus 500 may provide a cloud-based service 600. The apparatus 500 may be connected to charging stations of one or more charging station groups 602, 604, 606 via one or more data links or connections. The apparatus 500 may be configured to manage charging sessions provided at the charging stations of the charging station groups 602, 604, 606. As already discussed earlier, when receiving a charging request associated with a user, the apparatus 500 may be configured to determine whether the user belongs to a priority charging user group. The priority charging user group may have earlier been associated with a charging station group comprising a plurality of charging stations including the charging station. If the user belongs to the priority charging user group, the charging station may be transaction relating to the charging prioritized. The charging stations of single charging station group 602, 604, 606 may be located in the same geographical location or in at least two different geographical locations. In other words, charging stations can be logically grouped into a charging station group or groups irrespective of the geographical locations of the charging stations. Further, in an example embodiment, a first set of charging stations in a single geographical location may belong to a first charging station group and a second, different set of charging stations in the same geographical location may belong to a second, different charging station group.

In an example embodiment, the apparatus 500 may be configured to determine that there exists a validity condition associated with the user belonging to the priority charging user group, and prioritize the charging transaction relating to the charging station of the charging station group based on the validity condition associated with the user. The validity condition may be, for example, time and/or usage based. The validity condition may provide temporary or permanent priority rights to at least one user. This enables, for example, the use of vouchers and other temporary benefits as well as subscriptions of different lengths.

In an example embodiment, the apparatus 500 may be configured to determine that the user belongs to a priority charging group having a priority level, and prioritize the charging transactions relating to the charging station of the charging station group based on the priority level of the priority charging group. For example, the cloud-based solution may allow an operator to define multiple service levels with freely a configurable priorization hierarchy. As a n example of such a hierarchy, the hierarchy in a shopping center may be as follows:
Priority level 1: Local authorities (police, firefighting, ambulance)
Priority level 2: Facility security and maintenance personnel
Priority level 3: Premium customers with subscription
Priority level 4: Everyone else not listed above

In an example embodiment, the load management logic applied to the priority levels may be freely chosen. Possible logics may comprise, for example, first-in-first-out, even power share, and “round robin” (intermittent pausing).

One or more of the above discussed examples and embodiments may enable a use of one-time, fixed number as well as continuous service levels in load management for customers. This may enable, for example, the use of vouchers and other temporary benefits as well as subscriptions of different lengths. Further, one or more of the above discussed examples and embodiments may enable a solution in which a priority status of a user is not defined on a hardware level to certain charging stations, but on a cloud-based system for certain users. This may allow, for example, grouping of charging stations to one or more charging station groups to be done in a versatile and/or changing manner. Further, one or more of the above discussed examples and embodiments may enable a solution in which users may belong to different priority groups with different priority levels. Further, one or more of the above discussed examples and embodiments may enable a solution in which users can have different a priority status on different charging station groups. For example, a user may have a priority status at the user's office building, but not on public charging networks. Further, one or more of the above discussed examples and embodiments may enable a solution in which load management adjustments may be controlled remotely by the cloud-based solution.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus comprising:
at least one processor; and
at least one memory including computer program code, the at least one memory and the computer program code configured to, with the at least one processor, cause the apparatus at least to:
receive a charging transaction request associated with a user to charge an electric vehicle, the charging transaction request being associated with a charging station;
determine that the user belongs to a priority charging user group, the priority charging user group being associated with a charging station group comprising a plurality of charging stations including the charging station; and
prioritize the charging transaction relating to the charging station of the charging station group.

2. The apparatus according to claim 1, wherein the at least one memory and the computer program code are configured to, with the at least one processor, cause the apparatus at least to:
control to provide a full charging power of the charging station to the charging station of the charging station group.

3. The apparatus according to claim 1, wherein the at least one memory and the computer program code are configured to, with the at least one processor, cause the apparatus at least to:
control to share a total charging power of the charging stations of the charging station group between the charging station and at least one other charging station of the charging station group having a simultaneous charging transaction associated with at least one other user of the priority charging group.

4. The apparatus according to claim 1, wherein the at least one memory and the computer program code are configured to, with the at least one processor, cause the apparatus at least to:
control to provide a maximum charging power to the user and to at least one other user of the priority charging group with corresponding charging stations of the charging station group, and
control to share the remaining charging power of a total charging power of the charging stations of the charging station group to at least one non-priority user.

5. The apparatus according to claim 1, wherein the at least one memory and the computer program code are configured to, with the at least one processor, cause the apparatus at least to:
determine that the user belongs to a priority charging group having a priority level; and
prioritize the charging transactions relating to the charging station of the charging station group based on the priority level of the priority charging group.

6. The apparatus according to claim 1, wherein the charging stations of a charging station group are located in the same geographical location.

7. The apparatus according to claim 1, wherein the charging stations of a charging station group are located in at least two different geographical locations.

8. The apparatus according to claim 1, wherein the at least one memory and the computer program code are configured to, with the at least one processor, cause the apparatus at least to:
determine that there exists a validity condition associated with the user belonging to the priority charging user group; and
prioritize the charging transaction relating to the charging station of the charging station group based on the validity condition associated with the user.

9. The apparatus according to claim 1, wherein the at least one memory and the computer program code are configured to, with the at least one processor, cause the apparatus at least to:
identify each user based on a unique user identifier.

10. A method comprising:
receiving, by an apparatus, a charging transaction request associated with a user to charge an electric vehicle, the charging transaction request being associated with a charging station;
determining, by the apparatus, that the user belongs to a priority charging user group, the priority charging user group being associated with a charging station group comprising a plurality of charging stations including the charging station; and
prioritizing, by the apparatus, the charging transaction relating to the charging stations of the charging station group.

11. The method according to claim 10, further comprising:
controlling, by the apparatus, to provide a full charging power of the charging station to the charging station of the charging station group.

12. The method according to claim 10, further comprising:
controlling, by the apparatus, to share a total charging power of the charging stations of the charging station group between the charging station and at least one other charging station of the charging station group having a simultaneous charging transaction associated with at least one other user of the priority charging group.

13. The method according to claim 10, further comprising:
controlling, by the apparatus, to provide a maximum charging power to the user and to at least one other user of the priority charging group with corresponding charging stations of the charging station group, and
controlling, by the apparatus, to share the remaining charging power of a total charging power of the charging stations of the charging station group to at least one non-priority user.

14. The method according to claim 10, further comprising:
determining, by the apparatus, that the user belongs to a priority charging group having a priority level; and
prioritizing, by the apparatus, the charging transactions relating to the charging station of the charging station group based on the priority level of the priority charging group.

15. The method according to claim 10, wherein the charging stations of a charging station group are located in the same geographical location.

16. The method according to claim 10, wherein the charging stations of a charging station group are located in at least two different geographical locations.

17. The method according to claim 10, further comprising:
determining, by the apparatus, that there exists a validity condition associated with the user belonging to the priority charging user group; and
prioritizing, by the apparatus, the charging transaction relating to the charging station of the charging station group based on the validity condition associated with the user.

18. The method according to claim 10, further comprising:
identifying, by the apparatus, each user based on a unique user identifier.

19. A computer program comprising instructions for causing an apparatus to perform at least the following:
receiving a charging transaction request associated with a user to charge an electric vehicle, the charging transaction request being associated with a charging station;
determining that the user belongs to a priority charging user group, the priority charging user group being associated with a charging station group comprising a plurality of charging stations including the charging station; and
prioritizing the charging transaction relating to the charging station of the charging station group.
